(19) United States
(12) Patent Application Publication
(10) Pub. No.: US 2008/0267857 A1
(43) Pub. Date: Oct. 30, 2008

(54) RUTHENIUM CATALYSTS HAVING ENHANCED LONG-TERM STABILITY AND ACTIVITY

(75) Inventors: Oliver Felix-Karl Schlueter, Leverkusen (DE); Leslaw Mleczko, Dormagen (DE); Aurel Wolf, Wulfrath (DE); Stephan Schubert, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/108,116

(22) Filed: Apr. 23, 2008

(30) Foreign Application Priority Data
Apr. 26, 2007 (DE) 102007020143.7

(51) Int. Cl. B01J 27/128; C01B 7/04

(52) U.S. Cl. 423/502; 502/302; 502/226; 502/227; 502/224

(57) ABSTRACT

Oxidation catalysts comprising one or more ruthenium compounds and one or more promoters selected from the group consisting of zirconium halides, alkali metal halides, alkaline earth metal halides and lanthanum compounds, wherein the molar ratio of promoter to ruthenium is in the range of from 1:100 to 1:1; as well as processes for their preparation and use.

### RELATED APPLICATIONS

This application claims benefit to German Patent Application No. 10 2007 020 143.7, filed Apr. 26, 2007, which is incorporated herein by reference in its entirety for all useful purposes.

### FIELD OF THE INVENTION

The present invention is generally directed to oxidation catalysts comprising one or more ruthenium compounds and one or more promoters, wherein the molar ratio of promoter to ruthenium is in the range of from 1:100 to 1:1; as well as processes for their preparation and use.

### BACKGROUND OF THE INVENTION

U.S. Pat. No. 3,210,158 discloses the influence of certain actinoid series metals used as co-catalysts with copper catalysts supported on silicon dioxide in the Deacon reaction. All the metals investigated (Sc, Yb, Ce, Y, Dy, Gd, Pr, didymium, La, Nd, Eu, and Sm) effect a significant increase in the activity of the copper catalysts at a temperature in the range of from 300 to 400° C. However, no prolonging of the long-term stability of these catalysts was disclosed.

Slama et al. (Chem. Prum. 17 (4) (1967) 179) discloses increased activity for copper catalysts in the Deacon process that are promoted with Na, K, Nd, Y, and Th. A prolonging of the life was also to be detected for Y. However, promotion of the catalyst with Zr, Ce, Ag, Cr, Mn, Tl, and V had no effect on its activity.

In DE 197 34 412 A1, a ruthenium oxide catalyst promoted with CsNO₃ is disclosed. This promoted catalyst exhibits more than twice the activity of non-promoted ruthenium oxide catalyst. However, the long-term stability of this catalyst was not disclosed.

DE 102 34 576 teaches the use of copper chloride- or ruthenium chloride-based catalysts in the Deacon process, to which various metals can be added as promoters. DE 102 34 576 is silent about the effects of these metal promoters on the activity and long-term stability of the copper or ruthenium chloride catalyst.

### EMBODIMENTS OF THE INVENTION

An embodiment of the present invention is an oxidation catalyst comprising (1) a ruthenium compound and (2) a promoter selected from the group consisting of zirconium halides, alkali metal halides, alkaline earth metal halides, lanthanum compounds, and cesium compounds, wherein the molar ratio of promoter to ruthenium is in the range of from 1:100 to 1:1.

Another embodiment of the present invention is the above oxidation catalyst, wherein said halides are chlorides or oxychlorides.

Another embodiment of the present invention is the above oxidation catalyst, wherein said alkali metal halides are selected from the group consisting of lithium halides, sodium halides, potassium halides, cesium halides, and mixtures thereof.

Another embodiment of the present invention is the above oxidation catalyst, wherein said alkaline earth metal halides are selected from the group consisting of magnesium halides, manganese halides, cerium halides, and mixtures thereof.

Another embodiment of the present invention is the above oxidation catalyst, wherein said promoter is a zirconium halide, a cerium halide, or mixture thereof.

Another embodiment of the present invention is the above oxidation catalyst, wherein said ruthenium compound is ruthenium chloride.

Another embodiment of the present invention is the above oxidation catalyst, wherein the molar ratio of promoter to ruthenium is in the range of from 1:20 to 1:4.

Another embodiment of the present invention is the above oxidation catalyst, wherein the activity of said oxidation catalyst for the reaction of hydrogen chloride with oxygen with differential conversion under a pressure of 5 bar at a temperature of 300° C. is at least 5 mmol of chlorine per gram of ruthenium and per minute.

Another embodiment of the present invention is the above oxidation catalyst, wherein said catalyst is supported on a support material selected from the group consisting of silicon oxide, titanium oxide, aluminium oxide, tin oxide, zirconium oxide, and mixtures thereof.

Another embodiment of the present invention is the above oxidation catalyst, wherein the ratio of the weight of said oxidation catalyst to the total weight of said oxidation catalyst and said support material is in the range of from 0.5 to 5 weight percent.

Another embodiment of the present invention is the above oxidation catalyst, wherein the ratio of the weight of said oxidation catalyst to the total weight of said oxidation catalyst and said support material is in the range of from 1.0 to 4 weight percent.

Yet another embodiment of the present invention is a process for preparing chlorine gas comprising reacting hydrogen chloride with oxygen in the gas phase in the presence of an oxidation catalyst comprising (1) a ruthenium compound and (2) a promoter selected from the group consisting of zirconium halides, alkali metal halides, alkaline earth metal halides, lanthanum compounds, and cesium compounds, wherein the molar ratio of promoter to ruthenium is in the range of from 1:100 to 1:1.

Yet another embodiment of the present invention is a process for preparing an oxidation catalyst having enhanced activity and long-term stability comprising combining (1) a ruthenium compound and (2) a promoter selected from the group consisting of zirconium halides, alkali metal halides, alkaline earth metal halides, lanthanum compounds, and cesium compounds, in a molar ratio of promoter to ruthenium in the range of from 1:100 to 1:1.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawing:

FIG. 1 is a graph depicting the course of the space/time yield with respect to time for promoted and non-promoted catalyst.

### DESCRIPTION OF THE INVENTION

As used herein, the singular terms “a” and “the” are synonymous and used interchangeably with “one or more” and “at least one,” unless the language and/or context clearly indicate otherwise. Accordingly, for example, reference to “a promoter” herein or in the appended claims can refer to a single promoter or more than one promoter.

The invention provides an oxidation catalyst based on ruthenium, in particular based on ruthenium chloride, for catalytic processes, such as the catalytic gas phase oxidation of hydrogen chloride with oxygen (Deacon process), characterized in that the catalyst contains halide compounds chosen from the series consisting of: zirconium, alkali metal, in particular lithium, sodium, potassium and cesium, alkaline earth metal, in particular magnesium, manganese, cerium, or lanthanum compounds, preferably zirconium or cerium compounds, as a promoter in a molar ratio, based on the ruthenium content, of from 1:100 to 1:1 (promoter:ruthenium), preferably from 1:20 to 1:4 promoter:ruthenium). The activity of the ruthenium-based catalysts of the present invention is retained for the longest possible period of time, in particular for at least 3 hours.

In various preferred oxidation catalyst embodiments according to the present invention, the promoters are present in the form of chlorides or oxychloride.

In various preferred oxidation catalyst embodiments according to the present invention, the catalyst is supported on a support material selected from the group consisting of silicon oxide, titanium oxide, aluminium oxide, tin oxide and zirconium oxide and optionally mixture of these substances is particularly preferred.

In various preferred oxidation catalyst embodiments according to the present invention, the ratio of catalyst including promoter compounds to the total weight of the catalyst including support is preferably 0.5 to 5 wt. %, particularly preferably 1.0 to 4 wt. %.

In various preferred oxidation catalyst embodiments according to the present invention, the activity of the catalyst for the reaction of hydrogen chloride with oxygen with differential conversion under a pressure of 5 bar at a temperature of 300° C. is at least 5 mmol of chlorine per gram of ruthenium and minute.

The invention also provides for the use of the catalyst in gas phase oxidation processes, in particular in the reaction of hydrogen chloride with oxygen in the gas phase.

The invention furthermore provides for a process for the reaction of hydrogen chloride with oxygen in the gas phase in the presence of a catalyst, characterized in that a catalyst according to the present invention is used.

Preferably, the catalyst is employed in the catalytic process known as the Deacon process. In this process, hydrogen chloride is oxidized with oxygen in an exothermic equilibrium reaction to give chlorine, with water additionally being formed. The reaction temperature is conventionally 150 to 500° C. and the conventional reaction pressure is 1 to 25 bar. Since this is an equilibrium reaction, it is expedient to operate at the lowest possible temperatures at which the catalyst still has an adequate activity. It is furthermore expedient to employ oxygen in amounts which are in excess of stoichiometric amounts with respect to the hydrogen chloride. For example, a two- to four-fold oxygen excess is conventional. Since no losses in selectivity are to be feared, it may be of economic advantage to operate under a relatively high pressure and accordingly over a longer dwell time compared with normal pressure.

Suitable catalysts can be obtained, for example, by application of ruthenium chloride to the support and subsequent drying or drying and calcining, Suitable catalysts can also contain, in addition to a ruthenium compound, compounds of other noble metals, for example gold, palladium, platinum, osmium, iridium, silver, copper, or rhenium. Suitable catalysts can also contain chromium oxide.

The catalytic hydrogen chloride oxidation can preferably be carried out adiabatically or isothermally or approximately isothermally, discontinuously, but preferably continuously as a fluidized or fixed bed process, preferably as a fixed bed process, particularly preferably in tube bundle reactors over heterogeneous catalysts at a reaction temperature of from 180 to 500° C., preferably from 200 to 400° C., particularly preferably from 220 to 350° C. and under a pressure of from 1 to 25 bar (1,000 to 25,000 hPa), preferably from 1.2 to 20 bar, particularly preferably from 1.5 to 17 bar and in particular from 2.0 to 15 bar.

Conventional reaction apparatuses in which the catalytic hydrogen chloride oxidation is carried out are fixed bed or fluidized bed reactors. The catalytic hydrogen chloride oxidation can preferably also be carried out in several stages.

In the adiabatic, the isothermal or approximately isothermal procedure, several, e.g., 2 to 10, preferably 2 to 6, particularly preferably 2 to 5, more particularly preferably 2 to 3 reactors connected in series with intermediate cooling can also be employed. The hydrogen chloride can be added either completely together with the oxygen before the first reactor, or distributed over the various reactors. This connection of individual reactors in series can also be combined in one apparatus.

A further preferred embodiment of a device which is suitable for the process comprises employing a structured catalyst heap in which the catalyst activity increases in the direction of flow. Such a structuring of the catalyst heap can be effected by different impregnation of the catalyst support with the active composition or by different dilution of the catalyst with an inert material. Rings, cylinders or balls of, for example, titanium dioxide, zirconium dioxide or mixtures thereof, aluminium oxide, steatite, ceramic, glass, graphite or high-grade steel can be employed as the inert material. In the case of the preferred use of shaped catalyst bodies, the inert material should preferably have similar external dimensions.

Catalyst bodies are shaped bodies having any desired shape. Suitable shapes for the catalyst bodies include tablets, rings, cylinders, stars, wagon-wheels or balls, with rings, cylinders or star strands being particularly preferred. The dimensions (i.e., diameter in the case of balls) of the shaped bodies are preferably in the range of from 0.2 to 10 mm, particularly preferably 0.5 to 7 mm.

As an alternative to the finely divided (shaped) catalyst bodies described above, the support can also be a monolith of support material, e.g., not only a “conventional” support body having parallel channels which are not connected radially to one another; foams, sponges or the like having three-dimensional connections within the support body are also included in the monoliths, as wells as support bodies having cross-flow channels.

The monolithic support can have a honeycomb structure, but also an open or closed cross-channel structure. The monolithic support has a preferred cell density of from 100 to 900 cpsi (cells per square inch), particularly preferably from 200 to 600 cpsi.

A monolith in the context of the present invention is disclosed, e.g., in “Monoliths in multiphase catalytic processes—aspects and prospects” by F. Kapteijn, J. J. Heiszwolf, T. A. Nijhuis and J. A. Moulijn, Cattech 3, 1999, p. 24.

Suitable support materials are, for example, tin dioxide, silicon dioxide, graphite, titanium dioxide having the rutile or anatase structure, zirconium dioxide, aluminium oxide or mixtures thereof, preferably tin dioxide, titanium dioxide, zirconium dioxide, aluminium oxide or mixtures thereof, particularly preferably γ- or δ-aluminium oxide or mixtures thereof.

The ruthenium supported catalysts can be obtained, for example, by impregnation of the support material with aqueous solutions of RuCl₃ and the promoter for doping, preferably in the form of their chlorides. The shaping of the catalyst can be carried out after or, preferably, before the impregnation of the support material.

The shaped bodies can then be dried, and optionally calcined, at a temperature of from 100 to 500° C., preferably from 100 to 300° C., for example under a nitrogen, argon, oxygen or air atmosphere. Preferably, the shaped bodies are first dried at a temperature of from 100 to 150° C. and then calcined at a temperature of from 200 to 500° C.

The conversion of hydrogen chloride in a single pass can preferably be limited to 15 to 90%, preferably 40 to 85%, particularly preferably 50 to 80%. Some or all of the unreacted hydrogen chloride can be recycled into the catalytic hydrogen chloride oxidation after being separated off. The volume ratio of hydrogen chloride to oxygen at the reactor intake is preferably from 1:1 to 20:1, preferably from 2:1 to 8:1, particularly preferably from 2:1 to 5:1.

The heat of reaction of the catalytic hydrogen chloride oxidation can be used in an advantageous manner for generation of high pressure steam. This can be used for operation of a phosgenation reactor and/or of distillation columns, in particular isocyanate distillation columns.

In a last step of the Deacon process, the chlorine formed is separated off. The separating off step conventionally comprises several stages, namely separating off and optionally recycling unreacted hydrogen chloride from the product gas stream of the catalytic hydrogen chloride oxidation, drying of the stream obtained, which essentially contains chlorine and oxygen, and separating off chlorine from the dried stream.

The separating off of unreacted hydrogen chloride, and of the steam formed, can be carried out by condensing aqueous hydrochloric acid out of the product gas stream of the hydrogen chloride oxidation by cooling. Hydrogen chloride can also be absorbed into dilute hydrochloric acid or water.

The invention will now be described in further detail with reference to the following non-limiting examples.

### EXAMPLES

### Comparative Example

### Non-Promoted Catalyst

10 grams of ruthenium chloride n-hydrate were dissolved in 34 mL of water, to which 200 grams of support (SnO₂/Al₂O₃) (85:15 m/m); 1.5 mm) was then added and the components were mixed thoroughly until the solution had been absorbed by the support. The support impregnated in this way was left to stand for 1 hour. The moist solid was finally dried in the unwashed form in a muffle oven for 4 hours at 60° C. and 16 hours at 250° C.

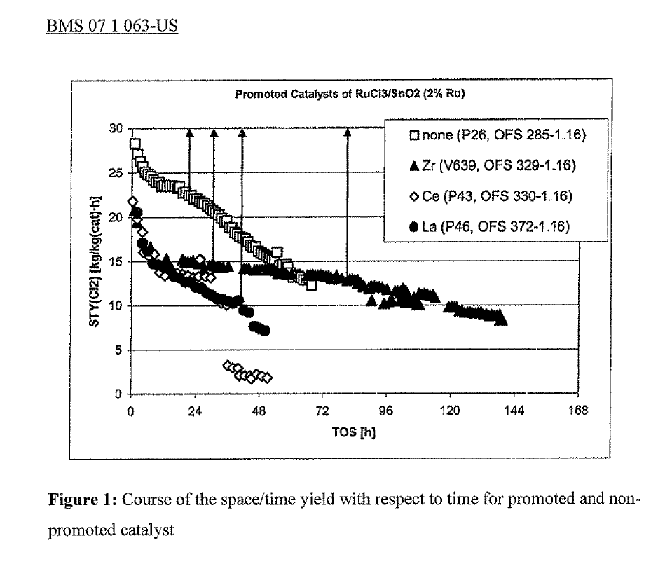

0.2 grams of the dried catalyst was diluted with 0.5 grams of SiO₂ (Saint Gobain; SS62138; 1.5 mm), and a flow of 80 mL/min (STP) of oxygen and 160 mL/min (STP) of hydrogen chloride was passed through the catalyst at 540° C. The amount of chlorine formed was determined via introduction into a 16% strength potassium iodide solution and titration of the iodine formed with thiosulfate. The course of the space/time yield with respect to time shown in FIG. 1 resulted.

### Example 1

### Zirconium-Promoted Catalyst

0.53 grams of ruthenium chloride n-hydrate and 0.048 grams of zirconium (IV) chloride were dissolved in 1.8 mL of water, to which 10 grams of support (SnO₂/Al₂O₃) (85:15 m/m); 1.5 mm) was then added and the components were mixed thoroughly until the solution had been absorbed by the support. The support impregnated in this way was left to stand for 1 hour. The moist solid was finally dried in the unwashed form in a muffle oven for 4 hours at 60° C. and 16 hours at 250° C.

0.2 grams of the dried catalyst was diluted with 0.5 grams of SiO₂ (Saint Gobain; 1.5 mm), and a flow of 80 mL/min (STP) of oxygen and 160 mL/min (STP) of hydrogen chloride was passed through the catalyst at 540° C. The amount of chlorine formed was determined via introduction into a 16% strength potassium iodide solution and titration of the iodine formed with thiosulfate. The course of the space/time yield with respect to time shown in FIG. 1 resulted.

### Example 2

### Cerium-Promoted Catalyst

0.53 grams of ruthenium chloride n-hydrate and 0.052 grams of cerium (III) chloride were dissolved in 1.8 mL of water, to which 10 grams of support (SnO₂/Al₂O₃) (85:15 m/m); 1.5 mm) was then added and the components were mixed thoroughly until the solution had been absorbed by the support. The support impregnated in this way was left to stand for 1 hour. The moist solid was finally dried in the unwashed form in a muffle oven for 4 hours at 60° C. and 16 hours at 250° C.

0.2 grams of the dried catalyst was diluted with 0.5 grams of SiO₂ (Saint Gobain; 1.5 mm), and a flow of 80 mL/min (STP) of oxygen and 160 mL/min (STP) of hydrogen chloride was passed through the catalyst at 540° C. The amount of chlorine formed was determined via introduction into a 16% strength potassium iodide solution and titration of the iodine formed with thiosulfate. The course of the space/time yield with respect to time shown in FIG. 1 resulted.

### Example 3

### Lanthanum-Promoted Catalyst

0.53 grams of ruthenium chloride n-hydrate and 0.079 grams of lanthanum (III) chloride heptahydrate were dissolved in 1.8 mL of water, to which 10 grams of support (SnO₂/Al₂O₃) (85:15 m/m); 1.5 mm) was then added and the components were mixed thoroughly until the solution had been absorbed by the support. The support impregnated in this way was left to stand for 1 hour. The moist solid was finally dried in the unwashed form in a muffle oven for 4 hours at 60° C. and 16 hours at 250° C.

0.2 grams of the dried catalyst was diluted with 0.5 grams of SiO₂ (Saint Gobain; 1.5 mm), and a flow of 80 mL/min (STP) of oxygen and 160 mL/min (STP) of hydrogen chloride was passed through the catalyst at 540° C. The amount of chlorine formed was determined via introduction into a 16% strength potassium iodide solution and titration of the iodine formed with thiosulfate. The course of the space/time yield with respect to time shown in FIG. 1 resulted.

FIG. 1 clearly shows the prolonging of the long-term stability of the promoted catalysts (>24 hours) compared with the non-promoted catalyst (18 hours).

### Examples 4 to 7

### Alkali Metal-Promoted Catalysts

0.53 grams of ruthenium chloride n-hydrate and 0.2 mmol of alkali metal chloride or nitrate were dissolved in 1.8 mL of water, to which 10 grams of support (SnO₂/Al₂O₃) (85:15 m/m); 1.5 mm) was then added and the components were mixed thoroughly until the solution had been absorbed by the support. The support impregnated in this way was left to stand for 1 hour. The moist solid was finally dried in the unwashed form in a muffle oven for 4 hours at 60° C. and 16 hours at 250° C.

0.2 grams of the dried catalyst was diluted with 0.5 grams of SiO₂ (Saint Gobain; 1.5 mm), and a flow of 80 mL/min (STP) of oxygen and 160 mL/min (STP) of hydrogen chloride was passed through the catalyst at 540° C. The amount of chlorine formed was determined via introduction into a 16% strength potassium iodide solution and titration of the iodine formed with thiosulfate. The space/time yields shown in Table 1 resulted.

TABLE 1
Activity of promoted catalysts at 300° C. (10 mol % promoter, based
on the amount of Ru, applied mass of catalyst w_{cat} = 0.2 grams,
applied mass of diluting material w_{SiO2} = 1.0 grams, volume flow
rate of HCl v_{HCl} = 80 mln/min, volume flow rate of oxygen v_{O2} = 80
mln/min; STY = space yield time)

| | STY (Cl₂) |
|---|---|
| Promoter | kg/h kg(cat) |
| non-promoted | 1.76 |
| Li | 1.98 |
| Mg | 1.86 |
| CsCl | 1.69 |
| CsNO₃ | 1.21 |

Table 1 shows no significant influence of various promoters on a RuCl₃/SnO₂ catalyst at a reaction temperature of 300° C. Only promotion with CsNO₃ shows a significant deterioration, which does not arise if CsCl is used.

1. An oxidation catalyst comprising (1) a ruthenium compound and (2) a promoter selected from the group consisting of zirconium halides, alkali metal halides, alkaline earth metal halides and lanthanum compounds, wherein the molar ratio of promoter to ruthenium is in the range of from 1:100 to 1:1.

2. The oxidation catalyst of claim 1, wherein said halides are chlorides or oxychlorides.

3. The oxidation catalyst of claim 1, wherein said catalyst is supported on a support material selected from the group consisting of silicon oxide, titanium oxide, aluminium oxide, tin oxide, zirconium oxide, and mixtures thereof.

4. The oxidation catalyst of claim 3, wherein the ratio of the weight of said oxidation catalyst to the total weight of said oxidation catalyst and said support material is in the range of from 0.5 to 5 weight percent.

5. The oxidation catalyst of claim 1, wherein the activity of said oxidation catalyst for the reaction of hydrogen chloride with oxygen with differential conversion under a pressure of 5 bar at a temperature of 300° C. is at least 5 mmol of chlorine per gram of ruthenium and per minute.

6. The oxidation catalyst of claim 1, wherein said alkali metal halides are selected from the group consisting of lithium halides, sodium halides, potassium halides, cesium halides, and mixtures thereof.

7. The oxidation catalyst of claim 1, wherein said alkaline earth metal halides are selected from the group consisting of magnesium halides, manganese halides, cerium halides, and mixtures thereof.

8. The oxidation catalyst of claim 1, wherein said promoter is a zirconium halide, a cerium halide, or mixture thereof.

9. The oxidation catalyst of claim 1, wherein said ruthenium compound is ruthenium chloride.

10. The oxidation catalyst of claim 1, wherein the molar ratio of promoter to ruthenium is in the range of from 1:20 to 1:4.

11. The oxidation catalyst of claim 4, wherein the ratio of the weight of said oxidation catalyst to the total weight of said oxidation catalyst and said support material is in the range of from 1.0 to 4 weight percent.

12. A process for preparing chlorine gas comprising reacting hydrogen chloride with oxygen in the gas phase in the presence of the catalyst of claim 1.

13. A process for preparing an oxidation catalyst having enhanced activity and long-term stability comprising combining (1) a ruthenium compound and (2) a promoter selected from the group consisting of zirconium halides, alkali metal halides, alkaline earth metal halides and lanthanum compounds, in a molar ratio of promoter to ruthenium in the range of from 1:100 to 1:1.
